(19) United States
(12) Patent Application Publication
(10) Pub. No.: US 2008/0046131 A1
(43) Pub. Date: Feb. 21, 2008

(54) Irrigation controller decoder converter

(76) Inventor: Larry C. Sarver, Canonsburg, PA (US)

Correspondence Address: THE WEBB LAW FIRM, P.C., 700 KOPPERS BUILDING, 436 SEVENTH AVENUE, PITTSBURGH, PA, 15219, US

(21) Appl. No.: 11/880,879

(22) Filed: Jul. 24, 2007

Related U.S. Application Data
(60) Provisional application No. 60/832,877, filed on Jul. 24, 2006.

(51) Int. Cl. G05D 7/00

(52) U.S. Cl. 700/284

(57) ABSTRACT

A method of converting a control system having steps of providing an existing control system having a centralized controller received within a housing and a plurality of independent control lines directly extending between a terminal strip in the controller and a corresponding plurality of assemblies to be controlled and a return line extending from the assemblies directly to the controller, wherein each control line receives a control signal from the controller; attaching an encoder to a pre-existing port on the controller housing; disconnecting the control lines from the assemblies; connecting the power lines from the terminal strip to an encoder; reconnecting the control lines from the terminal strip to the encoder, such that the power lines and control lines extend into the encoder and are connected thereto; and installing a control signal decoder in series with each of the assemblies for receiving signals from the encoder.

### CROSS-REFERENCE TO RELATED APPLICATION

This application claims the benefit of priority to U.S. Provisional Application No. 60/832,877 filed Jul. 24, 2006, entitled “Irrigation Controller Decoder Converter”, the disclosure of which is herein incorporated by reference in its entirety.

### BACKGROUND OF THE INVENTION

1. Field of the Invention

The present invention relates to a decoder for converting a multi-wire irrigation controller system to a two-wire system.

2. Description of Related Art

Conventional irrigation and watering systems used in commercial and residential locations include a main water supply line having a number of branch lines. Each of the branch lines includes at least one sprinkler head and a valve that operates the sprinkler head by operation of a solenoid or other control mechanism. Typically, a hard-wired remote central controller supplies individual low voltage power to a large number of control lines that extend along each of the supply lines. Each power line terminates at a solenoid and valve. A common line returns from each of the solenoids to complete the circuit. As such, each valve is controlled in essence by a separate circuit.

There are presently thousands of such multi-wire irrigation and watering systems throughout the United States that were installed over the past few decades. These conventional systems are difficult to modify. A new power line must be installed underground from the central controller to the new branch line and valve. The ground and other structures between the central controller of the new valve must be torn up to allow installation of a new power line. Oftentimes, this is difficult to perform due to the presence of buildings or hardscapes such as retaining walls, planters and patios.

One solution to this problem is described in U.S. Pat. No. 5,839,658, which discloses a method of retrofitting an existing irrigation system. The method includes installing a terminal strip within a controller of an irrigation system. Each of the valve control lines from the irrigation system receives a common signal from the controller. A control signal encoded within the controller provides encoded control signals for each of the individual assemblies. A control signal decoder is installed in series with each valve assembly. While this system avoids major disruption to landscape to retrofit an existing multi-wire irrigation system, it does require that the existing controller of the multi-wire system be disturbed in order to install an encoder therewith. In certain circumstances, there is inadequate space for installing an encoder with an existing controller.

### SUMMARY OF THE INVENTION

The present invention includes a method of converting a control system from a multi-wire system to a two-wire system. The method includes steps in any order of: providing an existing control system having a controller received within a housing and a plurality of independent control lines directly extending between a terminal strip in the controller and a corresponding plurality of assemblies to be controlled and a return line extending from the assemblies directly to the controller, wherein each control line receives a control signal from the controller; attaching an encoder to a pre-existing port on the controller housing; disconnecting the control lines from the assemblies; connecting the power lines from the terminal strip to the encoder; reconnecting the control lines from the terminal strip to the encoder, such that the power lines and control lines extend into the encoder and are connected thereto; and installing a control signal decoder in series with each of the assemblies for receiving signals from the encoder.

The present invention also includes a converted control system comprising a pre-existing control system comprising a controller, a controller housing, a plurality of control lines and power supply lines; an encoder attached to a port in said controller housing, wherein the control lines and power lines extend into said encoder and are connected thereto; and a two-wire circuit extending from said encoder, one wire being a control signal and the other wire being a return.

### BRIEF DESCRIPTION OF THE DRAWINGS

FIG. 1 is a schematic of installation of the encoder of the present invention threaded into an existing controller; and

FIG. 2 is a schematic of one embodiment of an encoder of the present invention.

### DESCRIPTION OF THE INVENTION

The present invention includes an encoder that is added to a pre-existing conventional controller to convert the controller, in whole or part, to two-wire decoder technology. The encoder converts a standard multi-wire controller to a two-wire controller. The encoder also allows for existing installations to add the two-wire conversion capability and take advantage of U.S. Pat. No. 5,839,658 to enable the conversion of existing multi-field installations.

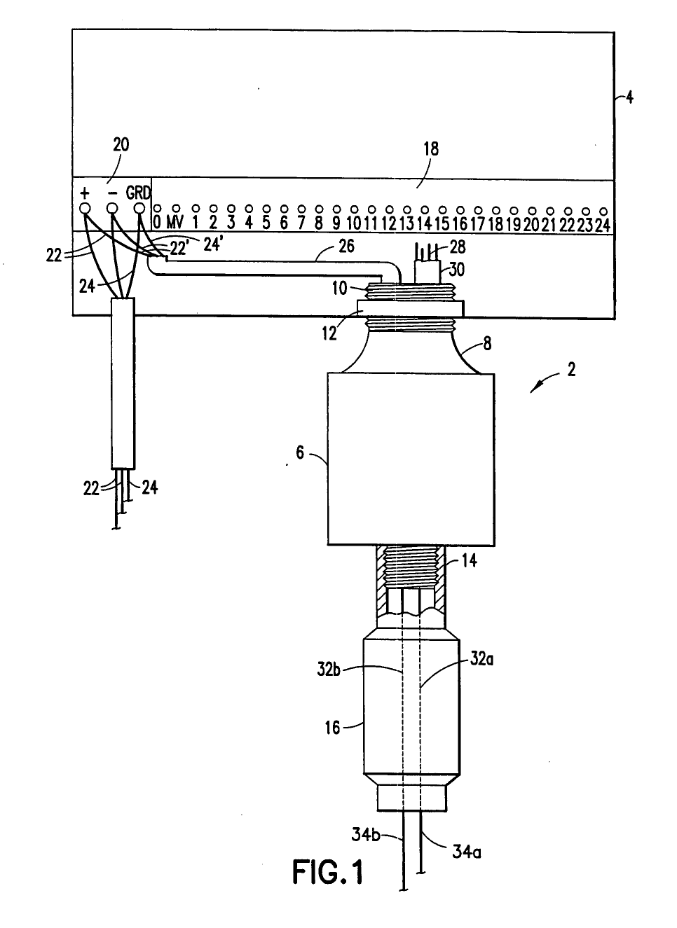

The present invention includes a method of retrofitting a pre-existing control system. Referring to FIG. 1, an encoder 2 is provided for use with a pre-existing control system having a housing 4. In one embodiment, encoder 2 includes an encoder housing 6 having a first threaded neck portion 8 for threading into a threaded port 10 of the pre-existing controller housing 4. The threaded port 10 of pre-existing controller housing 4 is conventionally provided to receive a conduit receiving multi-wire control lines into the controller housing 4. The present invention takes advantage of the presence of a threaded port 10 in most or nearly all controller housings that are commercially available. A lock-ring 12 is provided on the neck portion 8 for locking the neck portion 8 within the existing controller port 10.

The encoder housing 6 may also include a connector portion 14. Connector portion 14 may be threaded for connection to another component, such as a threaded junction box 16 as shown in FIG. 1.

A terminal strip 18 and associated power strip 20 are installed within controller housing 4. Pre-existing power lines 22 and ground line 24 extending into controller housing 4 are arranged to terminate at power strip 20. Corresponding power lines 22′ and ground line 24′ extend through conduit 26 into encoder 2 for supplying power thereto. A plurality of control lines 28 are connected from terminal strip 18 to extend through conduit 30 and provide control signals to encoder 2. Lines 22′, 24′ and 28 extend through necked portion 8 and into the encoder housing 6. The encoder housing 6 has threads molded into the body thereof such that the housing 6 may be installed much like wire conduit and junction boxes. This one-piece housing 6 provides for an outdoor water-tight mounting arrangement that is universal to virtually all current irrigation controllers on the market.

Encoder 2 operates in a manner similar to that described in U.S. Pat. No. 5,839,658, incorporated herein by reference. Encoder 2 provides each of the individual control signals from terminal strip 18 to control signal wire 32a. Control signal wire 32a is connected to a plurality of assemblies (not shown) for delivery of an encoded signal. Return wire 32b completes the circuit. Control signal wire 32a bearing encoded control signals extending from encoder 2 may be joined to field wire 34a at junction box 16. Likewise, return wire 32b may be joined to field return wire 34b at junction box 16. In one embodiment, the assemblies are irrigation assemblies, such as valves or sprinkler heads, with solenoids. Field wires 34a, b are connected to an irrigation control system (not shown) such as described in the '658 patent or other controllable system. A decoder (not shown) is installed with each assembly.

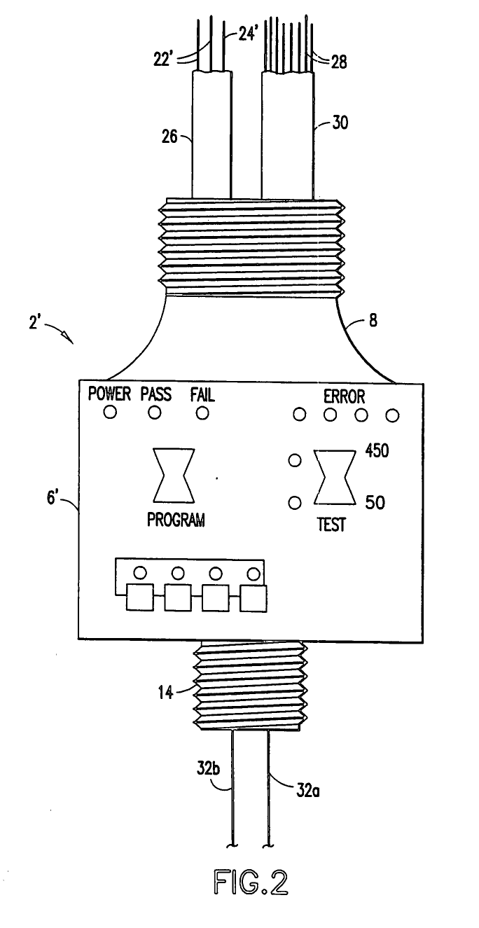

Encoder 2 may be pre-programmed prior to installation with the pre-existing controller. In another embodiment shown in FIG. 2, the exterior of the encoder 2′ includes a variety of control mechanisms for adjusting the control parameters of the system with which the encoder is installed.

The present invention is particularly suited for converting a pre-existing or new control system of an irrigation system to a two-wire system, but this is not meant to be limiting. Any control system in which different control signals are sent to various assemblies may be converted as described from a multi-wire system to a two-wire system.

1. A method of converting a multi-wire control system to a two-wire system comprising the steps of:
(a) providing an existing control system having a centralized controller received within a housing and a plurality of independent control lines directly extending between a terminal strip in the controller and a corresponding plurality of assemblies to be controlled and a return line extending from the assemblies directly to the controller, wherein each control line receives a control signal from the controller;
(b) attaching an encoder to a pre-existing port on the controller housing;
(c) disconnecting the control lines from the assemblies;
(d) connecting the power lines from the terminal strip to an encoder;
(e) reconnecting the control lines from the terminal strip to the encoder, such that the power lines and control lines extend into the encoder and are connected thereto; and
(f) installing a control signal decoder in series with each of the assemblies for receiving signals from the encoder.

2. The method of claim 1, further comprising threading the encoder into the port on the controller.

3. The method of claim 2, wherein the assemblies comprise irrigation assemblies.

4. A converted control system comprising:
a pre-existing control system comprising a controller, a plurality of control lines and power supply lines;
an encoder attached to an exterior of said controller, wherein the control lines and power lines extend into said encoder and are connected thereto; and
a two-wire circuit extending from said encoder, one wire being a control signal and the other wire being a return.

5. The system of claim 4, wherein the encoder is threaded into a housing of said controller.

6. The system of claim 5, wherein the control line is connected to a plurality of assemblies requiring control signals.

7. The system of claim 6, wherein said assemblies comprise irrigation assemblies.
